(19) United States
(12) Patent Application Publication
(10) Pub. No.: US 2007/0053278 A1
(43) Pub. Date: Mar. 8, 2007

(54) METHOD AND APPARATUS FOR CALCULATING A METRIC INDICATING THE SYMMETRY OF A SIGNAL WAVEFORM

(76) Inventors: Wei-Hsuan Tu, Hsinchu City (TW); Tse-Hsiang Hsu, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/461,432

(22) Filed: Jul. 31, 2006

Related U.S. Application Data
(60) Provisional application No. 60/596,177, filed on Sep. 7, 2005.

(51) Int. Cl. G11B 7/00

(52) U.S. Cl. 369/124.15

(57) ABSTRACT

A method for calculating a metric indicating a symmetry of a signal waveform includes inverting the signal waveform to produce an inverted signal waveform; measuring a first set of peak, bottom, and average values corresponding to the signal waveform by detecting a peak value of the signal waveform, detecting a bottom value of the signal waveform, and detecting an average value of the signal waveform; measuring a second set of peak, bottom, and average values of the inverted signal waveform by detecting a peak value of the inverted signal waveform, detecting a bottom value of the inverted signal waveform, and detecting an average value of the inverted signal waveform; and calculating the metric indicating the symmetry of the signal waveform according to the first set of peak, bottom, and average values of the signal waveform, and the second set of peak, bottom, and average values of the inverted signal waveform.

### CROSS REFERENCE TO RELATED APPLICATIONS

This application claims the benefit of U.S. Provisional Application No. 60/596,177, filed Sep. 7, 2005, entitled “Method and Apparatus for Improved Measurement of Waveform Signal” and included herein by reference.

### BACKGROUND

In optical disc recording operations, the recording power used in writing has a strong influence on the overall write quality of the reproduced disc. Optical discs are generally made up of an optical stack, including a sensitive dye layer and a reflective alloy layer. Data is written onto the discs using a high power laser onto the dye layer, and irreversibly altering it to create pits (poor reflection areas) and lands (highly reflective areas). The resulting sequence of pits and lands manage to physically encode the digital data stream. This data can then be later retrieved using an optical disc reader, which focuses a low power optical laser onto the pits and lands, and deciphers the reflected beam through a photo detector.

Precise recording power is therefore required such that the pits and lands are set at recommended levels. An incorrect level for a pit or land may result in quantization errors upon deciphering a reflected beam in an optical reader, and in extreme cases the disc may be rendered unreadable. To help ensure and monitor an acceptable quality of disc writing, some readers utilize an optimum power control (OPC) procedure, which is utilized to determine the optical recording power.

Recent developments have led to another method involving reading the outer track signal in order to further improve optimal recording power under high-speed operation. This method involves utilizing the symmetry of signals measured after recording to determine the optimal recording power. Ensuring symmetry in the measured signals will help maintain the proper signal swing from a pit to land measurement on the optical medium, and thus help control the recording power to an optimized level. The method entails calculating a symmetry parameter (β), that measures the relative symmetry of the measured signals.

The definition of β is subjective, and may vary between different devices and manufacturers. However, most definitions are derived from a calculation involving the peak level, bottom level, and time averaged value of a signal waveform to obtain the symmetry parameter (β). For example, some manufacturers define β as

$$β = \frac{P - D C}{P - B} \qquad ( 1 )$$

where P is the peak level, B is the bottom level, and DC refers to the time averaged value. A purely symmetric signal around an average level would render (β=0.5). Another common definition for β is

$$β = \frac{( P + B ) - 2 D C}{P - B} \qquad ( 2 )$$

in which a purely symmetric signal around an average level would render (β=0).

FIG. 1 shows a block diagram of a signal waveform measurement apparatus 100 of the related art for measuring the symmetry parameter β. An input signal waveform (Vin) is received into a Gain stage 110, which can be from the read/write head of the optical storage system. The output of the optional gain stage 110 is coupled to a Peak and Bottom Detector 120 and a signal averaging unit 130, utilized to determine the peak value, bottom value and time average value of the amplified signal respectively. These three values are passed to an Arithmetic Unit 140, which can be implemented by a digital or analog circuit structure. The Arithmetic Unit calculates the β value defined for a particular definition (for example, using eq. (1)) using the values obtained by the relevant detectors, and then provides the β value to the rest of the system. Using the calculated symmetry parameter β, a determination for potential adjustments to obtain the optimal recording power can be made. The apparatus of FIG. 1 may also include a Control Unit 150 for adjusting the synchronization and timing of the detectors, or for adjusting the gain/attenuation of the Gain Stage 110 according to the peak and bottom values received.

Although the structure and method of FIG. 1 does manage to produce a symmetry value β, this apparatus does not manage to overcome the possibility of inherent offsets in the peak/bottom detector measurements. As mentioned previously, these offsets will undoubtedly affect the obtained β value, and may provide inaccuracies in obtaining an optimized recording power level.

### SUMMARY

One objective of the claimed invention is therefore to provide an apparatus and method for calculating a metric indicating a symmetry of a signal waveform without being affected by offsets of peak/bottom detectors, to solve the above-mentioned problem.

According to an exemplary embodiment of the claimed invention, an apparatus for calculating a metric indicating a symmetry of a signal waveform is disclosed. The apparatus comprises a differential gain stage coupled to the signal waveform for producing an inverted signal waveform, a peak detector for detecting a peak value of a signal, a bottom detector for detecting a bottom value of a signal, a signal averaging unit for detecting an average value of a signal. The apparatus further comprises an arithmetic unit coupled to the peak level detector, bottom level detector, and the signal averaging unit for calculating the metric indicating the symmetry of the signal waveform according to a first set of peak, bottom, and average values corresponding to the signal waveform, and a second set of peak, bottom, and average values corresponding to the inverted signal waveform.

According to another exemplary embodiment of the claimed invention, an apparatus for calculating a metric indicating a symmetry between a signal waveform and an inverted signal waveform is disclosed. The apparatus comprising: a peak level detector for receiving the signal waveform; a bottom level detector for receiving the inverted signal waveform; a signal averaging unit; and an arithmetic unit coupled to the peak level detector, the bottom level detector, and the signal averaging unit for calculating the metric indicating the symmetry of the signal waveform according to a first set of peak, bottom, and average values corresponding to the signal waveform, and a second set of peak, bottom, and average values corresponding to the inverted signal waveform.

According to an additional exemplary embodiment of the claimed invention, a method for calculating a metric indicating a symmetry of a signal waveform is disclosed. The method comprises inverting the signal waveform to produce an inverted signal waveform, measuring a first set of peak, bottom, and average values corresponding to the signal waveform, measuring a second set of peak, bottom, and average values corresponding to the inverted signal waveform, and calculating the metric indicating the symmetry of the signal waveform according to the first set of peak, bottom, and average values corresponding to the signal waveform, and the second set of peak, bottom, and average values corresponding to the inverted signal waveform.

According to yet another embodiment of the present invention, a method for calculating a metric indicating a symmetry between a signal waveform and an inverted signal waveform is disclosed. The method comprising: measuring a first set of peak, bottom, and average values corresponding to the signal waveform by detecting a peak value of the signal waveform, detecting a bottom value of the signal waveform, and detecting an average value of the signal waveform; measuring a second set of peak, bottom, and average values corresponding to the inverted signal waveform by detecting a peak value of the inverted signal waveform, detecting a bottom value of the inverted signal waveform, and detecting an average value of the inverted signal waveform; and calculating the metric indicating the symmetry of the signal waveform according to the first set of peak, bottom, and average values corresponding to the signal waveform, and the second set of peak, bottom, and average values corresponding to the inverted signal waveform.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a signal waveform measurement apparatus for measuring a symmetry parameter β according to related art.

FIG. 2 illustrates a block diagram of a signal symmetry measurement apparatus according to a first embodiment of the present invention.

FIG. 3 illustrates a block diagram of a signal symmetry measurement apparatus utilizing a single stage of operation according to a second embodiment of the present invention.

FIG. 4 illustrates a block diagram of a signal symmetry measurement apparatus utilizing a multiplexer according to a third embodiment of the present invention.

FIG. 5 illustrates a flowchart describing a method of calculating a metric indicating a symmetry of a signal waveform according to an exemplary embodiment of the present invention.

FIG. 6 illustrates an embodiment of the signal symmetry measurement apparatus 600 for calculating a metric indicating symmetry between a signal waveform and an inverted signal waveform.

FIG. 7 shows another embodiment of the signal symmetry measurement apparatus 700 for calculating a metric indicating symmetry between a signal waveform and an inverted signal waveform.

FIG. 8 illustrates an exemplary flowchart describing a method for calculating a metric indicating symmetry between a signal waveform and an inverted signal waveform.

### DETAILED DESCRIPTION

From the above description, it is clear that the accuracy of the β measurement directly influences the write quality of an optical storage system. To ensure that a true and accurate β is obtained, the peak levels, bottom levels, and time average values of the signal waveform must be precisely measured. In practice however, this is very difficult to achieve. Variations in the manufacturing of peak detectors and other relevant integrated circuits (ICs) tend to provide different offsets to the measured values. The specific frequency of the input waveforms also tends to alter the measured values as well. These issues make it very difficult to determine a true and accurate symmetry parameter β using existing definitions and methodologies.

A goal of the present invention is to overcome the various offsets in peak/bottom detectors by utilizing a new signal inversion algorithm to determine the symmetry parameter (β). This method manages to overcome the inherent differences between IC offsets and speed settings. Utilizing this method, a more accurate β is obtained, determination of the optimum writing power simplified, and the overall write quality and error reduction rate is improved.

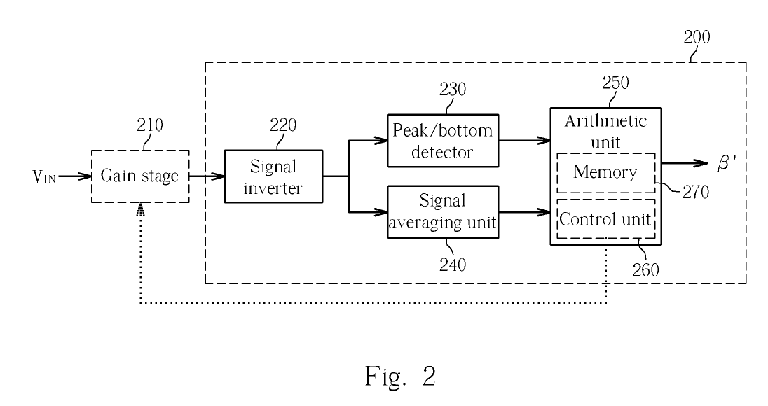

FIG. 2 shows a signal symmetry measurement apparatus 200 according to a first embodiment of the present invention. The structure and method for this signal symmetry measurement apparatus 200 will be concisely explained in the following. A signal waveform represented by Vin is inputted into an optional gain stage 210, which serves to amplify/attenuate the input waveform to a desired level. This signal waveform may correspond to a read signal from a write procedure in optical disc recording, or another relevant source. It is then followed by a signal inverter 220, which serves to invert the signal or change the polarity to produce an inverted signal waveform. The signal inverter 220 may consist of a gain controlled operational amplifier. The output of the signal inverter 220 forms an intermittent signal, which comprises the normal signal waveform, and the inverted signal waveform being time division multiplexed. That is, this intermittent signal consists of solely the normal signal for a limited time duration, followed by consisting of solely the inverted signal for a remaining period.

The intermittent signal outputted by the signal inverter 220 is coupled in parallel to a combination Peak/Bottom detector 230, and to a signal averaging unit 240. Although the Peak/Bottom detector 230 and the signal averaging unit 240 are shown in a mixed configuration in this embodiment, in alternate embodiments, they may exist independently, or in another mixed combination. The peak detector of the combination peak/bottom detector 230 serves to detect the peak value of a signal, whereas the bottom detector serves to detect the bottom value of an inputted signal. The signal averaging unit 240 simply serves to detect the time average value of a signal, and may consist of a circuit such as a low pass filter.

In this embodiment, the arithmetic unit 250 receives the outputs of the Peak/Bottom detector 230 and the signal averaging unit 240 in two stages. In one embodiment, a first stage corresponds to when the signal inverter 220 outputs the normal signal waveform, and a second stage corresponds to when the signal inverter 220 outputs the inverted signal waveform. Of course, in another embodiment, this order could also be reversed. In the first stage, the peak/bottom detector 230 and the signal averaging unit 240 measure and send the peak value, bottom value, and average value respectively, of either a normal signal waveform or an inverted signal waveform. These values are stored into a memory unit 270 coupled to the arithmetic unit 250 for subsequent use. In the second stage, the peak value, bottom value, and average value of either the normal signal waveform or the inverted signal waveform not used in the first stage is measured and sent. The arithmetic unit 250 then proceeds to calculate the metric for determining the symmetry of the input waveform (β′) based on the parameters received in the second stage of operation and that stored in the memory unit 270, utilizing an alternate formula described later. For optical recording procedures, this metric can be used accordingly to control and optimize recording power. The arithmetic unit 250 may also comprise a Control Unit 260, from which it can adjust or calibrate the initial gain stage to a desired level, or control other components of the circuit not shown.

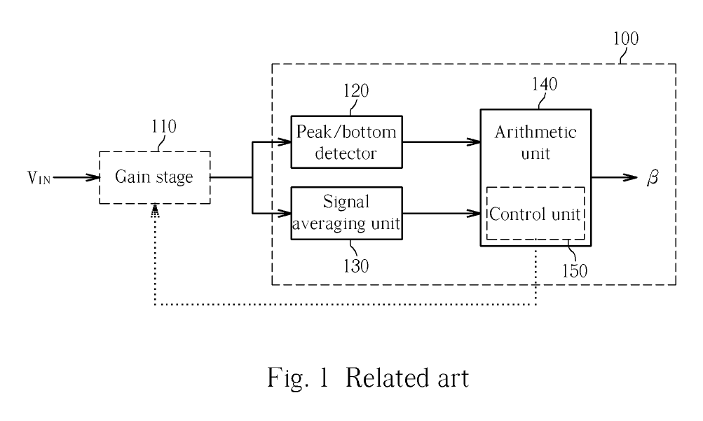

In comparison with the related art of FIG. 1, the present invention as shown in FIG. 2 differs structurally through the addition of a signal inverter 220 in the signal path. The methodology and operation of the present signal symmetry measurement apparatus 200 also differ, in that the arithmetic unit utilizes an alternate formula that manages to overcome the potential for offsets in the peak/bottom detectors. According to this method, signal inversion is utilized to provide both the original (normal) signal waveform and its inverse signal waveform in two separate stages to thereby obtain two interim β values, βₙ and βᵢ. The two interim β values (β_{n,i}) are computed in an alternate formula, which negates the offsets from the peak and bottom detectors and to obtain a final β′ value that represents the metric indicating the symmetry of a signal waveform. This final β′ value is independent of offset variations. Formulations in the following will also reveal that this final β′ is also independent of different IC speeds. In this manner, the accuracy of the metric indicating the symmetry of a signal waveform is vastly improved.

The following discussion now further details how the arithmetic unit 250 calculates the final metric (β′) indicating the symmetry of a signal waveform and related formulae according to this embodiment of the present invention.

Using the following definitions:

βₙ is the normal (non-inverted) interim beta signal, and

βᵢ is the inverted interim beta signal, and

β′ is the final beta

The final beta utilizing the signal inversion method can be described by

$${β}^{′} = 0.5 + \frac{{β}_{n} - {β}_{I}}{2} \qquad ( 3 )$$

Where βₙ, βᵢ can be given by application of formulas (1) or (2) shown earlier, and are calculated by the arithmetic unit 250 according to the peak, bottom, and average values measured during the first stage and second stage, respectively.

Using the definition of β′ described above in (3), the advantages of using the signal inversion method will be displayed through the use of several examples below. The following variables are described below for later use.

Variable Definitions:
P₁, B₁ are the real peak and bottom signal values of IC1
P₁, B₂ are the real peak and bottom signal values of IC2
ΔP₁, ΔB₁ are the peak and bottom offset values of IC1
ΔP₂, ΔB₂ are the peak and bottom offset values of IC2
DCₙ is a time averaged measurement of the normal signal,
DCᵢ is a time averaged measurement of the inverted signal,

Case I: Different ICs (Speed), Different Offset, but Same Signal Swing (Vpp)

In the first case, the difference in obtained beta values for the same signal from two different ICs operating at different speeds are compared. The offset values (ΔP₁, ΔB₁, ΔP₂, ΔB₂) are assumed to vary in each IC.

It is further assumed in this case that the measured Peak to Bottom signal swing (Vpp) in each IC has been adjusted such that they are equal.
P−B=[(P₁+ΔP₁)−(B₁−ΔB₁)]=[(P₂+ΔP₂)−(B₂−ΔB₂)] (4)

For IC1, the interim betas can be described by

$$\begin{matrix}{β}_{1 , n} = \frac{P - D {C}_{n}}{P - B} = \frac{{P}_{1} + Δ {P}_{1} - D {C}_{n}}{P - B} & ( 5 ) \\ {β}_{1 , i} = \frac{( P + Δ ) - ( D {C}_{i} + Δ )}{P - B} = \frac{{P}_{1} + Δ {P}_{1} - D {C}_{i}}{P - B} & ( 6 )\end{matrix}$$

Inserting the interim beta values into (3) we have:

$$\begin{matrix}{β}_{1}^{′} = 0.5 + \frac{{β}_{1 , n} - {β}_{1 , i}}{2} \\ = 0.5 + \frac{\frac{1}{2} ( D {C}_{i} - D {C}_{n} )}{P - B} \\ = \frac{\frac{1}{2} ( P - B ) - \frac{1}{2} ( D {C}_{i} - D {C}_{n} )}{P - B}\end{matrix} \qquad ( 7 )$$

Repeating the same steps for IC2, we can come to

$$\begin{matrix}{β}_{ 2}^{ ′} = 0.5 + \frac{{β}_{2 , n} - {β}_{2 , I}}{2} \\ = 0.5 + \frac{\frac{1}{2} ( D {C}_{i} - D {C}_{n} )}{P - B} \\ = \frac{\frac{1}{2} ( P - B ) - \frac{1}{2} ( D {C}_{i} - D {C}_{n} )}{P - B}\end{matrix} \qquad ( 8 )$$

A visual comparison (7) and (8) of the above will show
β₁′=β₂′

Therefore, in the case where the signal swing has been equally scaled in two different ICs, the same beta values can be obtained regardless of differences in peak and bottom offsets of each individual IC.

To compare this result with the original method of the related art, the following discussion is presented.

The interim beta value from IC1 operating at Speed 1 is

$$\begin{matrix}{β}_{ 1 , n} = \frac{P - D {C}_{n}}{P - B} \\ = \frac{{P}_{1} + Δ {P}_{1} - D {C}_{n}}{P - B}\end{matrix} \qquad ( 9 )$$

The interim beta value from IC2 operating at Speed 2 is

$$\begin{matrix}{β}_{ 2 , n} = \frac{P - D {C}_{n}}{P - B} \\ = \frac{{P}_{1} + Δ {P}_{2} - D {C}_{n}}{P - B}\end{matrix} \qquad ( 10 )$$

The relative differences in beta values is

$$\begin{matrix}Δ β = {β}_{1 , n} - {β}_{2 , n} \\ = \frac{Δ {P}_{1} - Δ {P}_{2}}{P - B}\end{matrix} \qquad ( 11 )$$

When writing this error in percentage form results in

$$\% error = \frac{Δβ}{{β}_{1}} = \frac{Δ {P}_{1} - Δ {P}_{2}}{P - D {C}_{n}} \qquad ( 12 )$$

Entering typical values to arrive at a numerical result, a signal swing=1 V is used, resulting in
(P−DCₙ)=0.5V, ΔP₁−ΔP₂=50 mV [symbol] error=10%

Case II: Different ICs (Speed), Different Offsets and Different Signal Swing (Vpp)

In this case, the measured values for beta using ICs of different speed settings is considered, where the peak and bottom offsets also vary. It is further assumed that the signal swing (Vpp) between the two ICs also differ such that
Vpp=P−B=[(P₁+ΔP₁)−(B₁−ΔB₁)]=[(P₂+ΔP₂)−(B₂−ΔB₂)+ΔV] (13)
Where ΔV represents the swing error.

The data value from IC1 operating at Speed 1 is given by

$${β}_{1}^{′} = \frac{\frac{1}{2} ( P - B ) - \frac{1}{2} ( D {C}_{i} - D {C}_{n} )}{P - B} \\ = 0.5 - \frac{\frac{1}{2} ( D {C}_{i} - D {C}_{n} )}{P - B} \qquad ( 14 )$$

The data value from IC2 operating at Speed 2 is given by

$${β}_{2}^{′} = \frac{\frac{1}{2} ( P - B - Δ V ) - \frac{1}{2} ( D {C}_{i} - D {C}_{n} )}{P - B - Δ V} \\ = 0.5 - \frac{\frac{1}{2} ( D {C}_{i} - D {C}_{n} )}{P - B - Δ V} \qquad ( 15 )$$

Entering some common values to arrive at a numerical result, the following is used
P₁=2V, B₁=1V, DCₙ=1.48, ΔP₁=0.2, ΔB₁=−0.1

Entering these numbers into the above, a numerical beta value for IC1 is obtained

$$\begin{matrix}{β}_{1}^{′} = \frac{\frac{1}{2} ( 2.2 - 1.1 ) + \frac{1}{2} ( 1.52 - 1.48 )}{2.2 - 1.1} \\ = 0.5182 ( 4245 )\end{matrix} \qquad ( 16 )$$

Assuming that IC2 has a swing difference of 0.8 (ΔV=0.2), we arrive at a numerical beta value for IC2 of

$$\begin{matrix}{β}_{2}^{′} = \frac{\frac{1}{2} ( 2.2 - 1.1 - 0.2 ) + \frac{1}{2} ( 1.52 - 1.48 )}{2.2 - 1.1 - 0.2} \\ = 0.5222 ( 4278 )\end{matrix} \qquad ( 17 )$$

Through comparison of (16) and (17), it is evident that a 20% swing difference only influences the beta value by 1%.

From the above, it is shown that if the signal swing is different, it is only required that beta approaches 0.5(4096), and the signal swing difference will be reduced. Additionally when using the same beta values, the influence of the swing change will be slightly reduced as the signal swing increases. The above example shows that the beta values will not be overly sensitive to a sizeable variation in swing difference.

Case III: A Comparison of the Previous Method with the Method of the Present Invention Using the Absolute Difference of an Ideal Beta.

(1) IC1 (Speed 1)

Making a slight variation of the formula of Case 1 results in the following formula:

$$\begin{matrix}{β}_{1}^{′} = \frac{\frac{1}{2} ( P - B ) - \frac{1}{2} ( D {C}_{i} - D {C}_{n} )}{P - B} \\ = \frac{\frac{1}{2} ( P - B ) - [ \frac{1}{2} ( {P}_{1} - {B}_{1} ) - Δ ]}{P - B} \\ = \frac{Δ + \frac{1}{2} ( Δ {P}_{1} + Δ {B}_{1} )}{{P}_{1} - {B}_{1} + Δ {P}_{1} + Δ {B}_{1}}\end{matrix} \qquad ( 18 )$$

where Δ≡P₁−DCₙ

And the real beta is given by

$${β}_{real} = \frac{{P}_{1} - D {C}_{n}}{{P}_{1} - {B}_{1}} = \frac{Δ}{{P}_{1} - {B}_{1}} \qquad ( 19 )$$

As can be seen from the above formula, when the beta has the ideal value of 0.5, the new measurement method does not possess any discrepancy or error. The following example will show that if beta is an alternate value, the absolute error value using the method of the present invention will be less than that obtained through the method of the related art.

The following numerical values are used to illustrate this point
P₁=2V, B₁=1V, DCₙ=1.53, (Δ=0.47)

These values are substituted in the following examples with other typical values to provide a comparison between obtaining a Beta value using the related art, and that of the present method.

The actual (real) value for Beta given for comparison purposes is:

$${β}_{real} = \frac{Δ}{{P}_{1} - {B}_{1}} = 0.47 ( 3850 ) \qquad ( 20 )$$

The following examples compare numerically calculated values for the symmetry parameter Beta using the method of the related art described in (1), with the new signal inversion method described in (3)

### EXAMPLE 1 ΔP₁=0.3, ΔB₁=0.3

$${β}_{1} = \frac{2.3 - 1.53}{2.3 - 0.7} = 0.4812 ( 3942 ) Error \text{:} 92$$

$${β}_{1}^{′} = \frac{0.47 + \frac{1}{2} ( 0.6 )}{2.3 - 0.7} = 0.4812 ( 3942 ) Error \text{:} 92$$

### EXAMPLE 2 ΔP₁=0.3, ΔB₁=−0.3

$${β}_{1} = \frac{2.3 - 1.53}{2.3 - 1.3} = 0.77 ( 6208 ) Error \text{:} 2458$$

$${β}_{1}^{′} = \frac{0.47 + \frac{1}{2} ( 0 )}{2.3 - 0.7} = 0.47 ( 3850 ) Error \text{:} 0$$

### EXAMPLE 3 P₁=0.3, ΔB₁=0.2

$${β}_{1} = \frac{2.3 - 1.53}{2.3 - 0.8} = 0.5133 ( 4205 ) Error \text{:} F355$$

$${β}_{1}^{′} = \frac{0.47 + \frac{1}{2} ( 0.5 )}{2.3 - 0.8} = 0.48 ( 3932 ) Error \text{:} 82$$

The above examples clearly show that through utilization of the signal inversion method of (3), a more accurate beta measurement will obtained that more closely resembles the actual beta value.

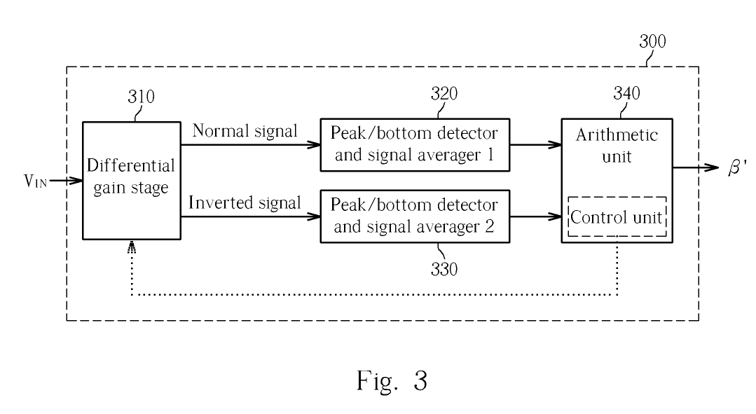

FIG. 3 shows an alternate embodiment of the signal symmetry measurement apparatus 300. As will be understood by a person skilled in the art, differential implementations have much greater common-mode noise rejection and are therefore often used in high-speed integrated circuit environments. To take advantage of hardware already present to form differential signals, in this embodiment, the differential gain stage 310 simultaneously outputs the input signal waveform and an inverted signal waveform as a differential pair. Because the original (normal) signal and its inverse are provided simultaneously in a single stage of operation according to this embodiment, a second set of peak/bottom detectors, and another signal averaging unit 330 is required. The embodiment of FIG. 3 makes use of a combination of peak/bottom detectors and a signal averaging unit in a single device block 320, 330, however, these may be utilized as separate independent units or another alternate combination in further embodiments.

The first set of combination peak/bottom detectors and signal averaging unit 320 in FIG. 3 receives the normal signal waveform, while the second set of combination peak/bottom detectors and signal averaging unit 330 receives the inverted signal waveform. Provided that the possible mismatch between the two sets of Peak and Bottom Detectors are within an acceptable range, this embodiment can also be used to carry out a determination for the metric indicating the symmetry of a signal waveform β′ in a single stage of operation. As described previously, the peak, bottom and average values of both the normal signal waveform and the inverse signal waveform are simultaneously received and utilized by the arithmetic unit 340 to obtain two interim (βₙ, βᵢ) values. These interim βₙ, βᵢ values are further operated upon by the arithmetic unit 340 using an alternate formula to obtain the metric indicating the symmetry of a signal waveform β′ independent of offset variations in the peak/bottom detectors. For example, the alternate formula (3) shown above can be utilized to calculate the metric indicating the symmetry of a signal waveform β′.

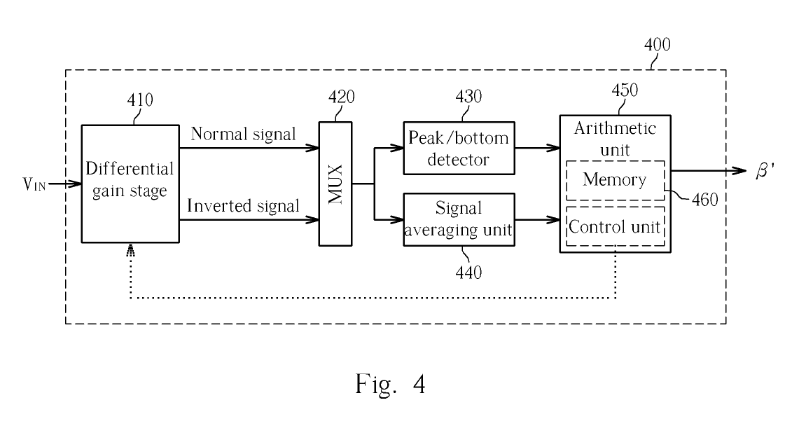

FIG. 4 shows yet another embodiment of a signal symmetry measurement apparatus 400 according to the present invention. This embodiment manages to utilize a single set of peak/bottom detectors 430 and a signal averaging unit 440, while simultaneously receiving the differential pair of normal signal waveform and inverted signal waveform. As with the previous embodiment, a differential gain stage 410 is utilized, c simultaneously producing a differential pair comprising a signal waveform, and an inverted signal waveform, from an input source Vin. A multiplexer (MUX) 420 is used to select one of the signal waveform or inverted signal waveform at a time from the differential pair to pass through to the set of Peak/Bottom detectors 430 and signal averaging unit 440. In this manner, the output of the MUX 420 constitutes an intermittent signal that is time division multiplexed between the normal signal waveform and the inverted signal waveform.

The intermittent signal is thus coupled to the peak/bottom detector 430 and the signal averaging unit 440. In a first stage of operation, the multiplexer 420 outputs the intermittent signal as one of either the signal waveform or inverted signal waveform. The peak/bottom detector 430 and signal averaging unit 440 measure the peak, bottom and average values respectively, and store these values into the memory unit 460 coupled to the arithmetic unit 450. In the second stage of operation, the multiplexer 420 outputs the intermittent signal as either the signal waveform or inverted signal waveform not used in the first stage of operation. The peak, bottom and average values are then measured with the peak/bottom detector 430 and signal averaging unit 440 and sent to the arithmetic unit 450. The arithmetic unit 450 then calculates the metric indicating the symmetry of the signal waveform β′ according to the values stored in memory 460 and the peak, bottom, and average values as measured in the second stage of operation by the peak/bottom detector 430, and the signal averaging unit 440.

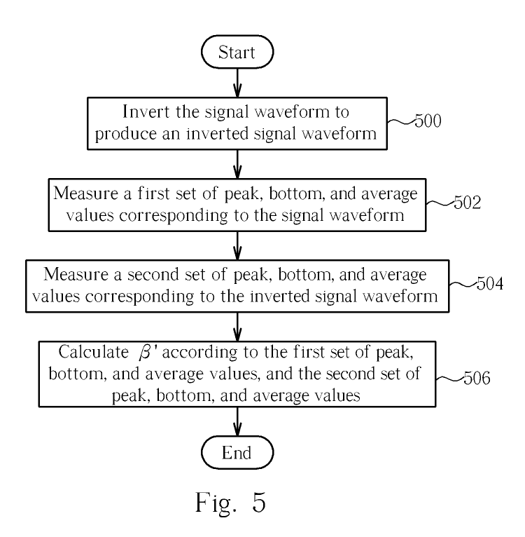

Although a limited number of embodiments are described above, please note that other embodiments of the present invention may also be realized provided that substantially the same result is achieved. FIG. 5 illustrates a flowchart describing a method of calculating a metric indicating a symmetry of a signal waveform according to an exemplary embodiment of the present invention. Provided that substantially the same result is achieved, the steps of the signal inversion method shown in FIG. 5 need not be in the exact order shown and need not be contiguous, that is, other steps can be intermediate. In this embodiment, calculating a metric indicating a symmetry of a signal waveform includes the following steps:

Step 500: Invert the signal waveform to produce an inverted signal waveform.

Step 502: Measure a first set of peak, bottom, and average values corresponding to the signal waveform.

Step 504: Measure a second set of peak, bottom, and average values corresponding to the inverted signal waveform.

Step 506: Calculate the metric indicating the symmetry of the signal waveform (β′) according to the first set of peak, bottom, and average values, and the second set of peak, bottom, and average values.

As will be apparent from the description of the previous embodiments, steps 502 and step 504 may be performed in parallel or in sequence depending upon the particular hardware implementation of the method.

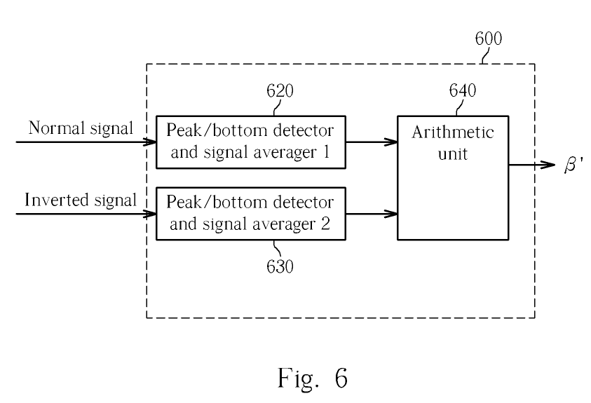

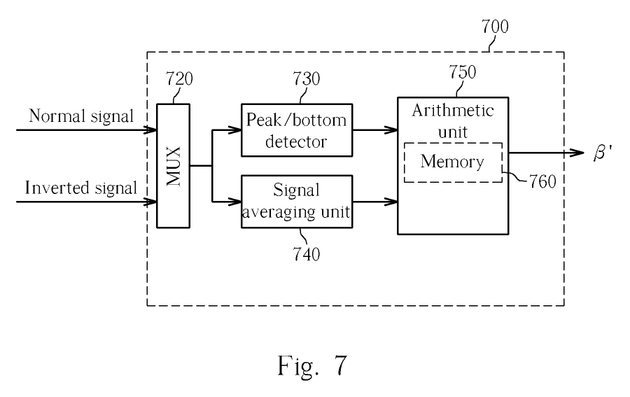

In some circumstances, both a signal waveform and inverted signal waveform may be simultaneously provided. In this instance, it may be desired to calculate a metric indicating a symmetry between the provided signal waveforms and inverted signal waveforms. This can additionally be accomplished with minimal modification to the embodiments presented above, and is described in additional embodiments below with reference to FIG. 6 and FIG. 7.

FIG. 6 shows an embodiment of the signal symmetry measurement apparatus 600 for calculating a metric indicating a symmetry between a signal waveform and an inverted signal waveform. In this embodiment, the input signal waveform (normal signal) and inverted signal waveform (inverted signal) are both simultaneously outputted as a differential pair. A second set of peak/bottom detectors, and another signal averaging unit 630 is required in this embodiment due to the differential pair received. A combination of peak/bottom detectors and signal averaging unit 620, 630 are utilized within single device blocks. However, these may be utilized as separate independent units in alternate combinations or further embodiments.

The first set of combination peak/bottom detectors and signal averaging unit 620 in FIG. 6 receives the normal signal waveform, while the second set of combination peak/bottom detectors and signal averaging unit 630 receives the inverted signal waveform. If the possible mismatch between the two sets of Peak and Bottom Detectors are within an acceptable range, this embodiment can also be used to determine the metric indicating the symmetry of a signal waveform β′ in a single stage of operation. As with previous embodiments, the peak, bottom and average values of both the normal signal waveform and the inverse signal waveform are simultaneously received and utilized by the arithmetic unit 640 to obtain two interim (βₙ, βᵢ) values. These interim βₙ, βᵢ values are further operated upon by the arithmetic unit 640 using an alternate formula to obtain the metric indicating the symmetry of a signal waveform β′ independent of offset variations in the peak/bottom detectors, such as alternate formula (3) for example.

FIG. 7 shows another embodiment of the signal symmetry measurement apparatus 700 for calculating a metric indicating a symmetry between a signal waveform and an inverted signal waveform. This embodiment manages to utilize a single set of peak/bottom detectors 730 and a signal averaging unit 740, while simultaneously receiving the differential pair of a normal signal waveform and an inverted signal waveform. As in the last embodiment, a differential pair comprising a signal waveform and an inverted signal waveform is output. A multiplexer (MUX) 720 is used to select one of the signal waveform or inverted signal waveform at a time from the differential pair to pass through to the set of Peak/Bottom detectors 730 and signal averaging unit 740. In this manner, the output of the MUX 720 constitutes an intermittent signal that is time division multiplexed between the normal signal waveform and the inverted signal waveform.

The intermittent signal is thus coupled to the peak/bottom detector 730 and the signal averaging unit 740. In a first stage of operation, the multiplexer 720 outputs the intermittent signal as one of either the signal waveform or inverted signal waveform. The peak/bottom detector 730 and signal averaging unit 740 measure the peak, bottom and average values respectively, and store these values into the memory unit 760 coupled to the arithmetic unit 750. In the second stage of operation, the multiplexer 720 outputs the intermittent signal as either the signal waveform or inverted signal waveform not used in the first stage of operation. The peak, bottom and average values are then measured with the peak/bottom detector 730 and signal averaging unit 740 and sent to the arithmetic unit 750. The arithmetic unit 750 then calculates the metric indicating the symmetry of the signal waveform β′ according to the values stored in memory 760 and the peak, bottom, and average values as measured in the second stage of operation by the peak/bottom detector 730, and the signal averaging unit 740.

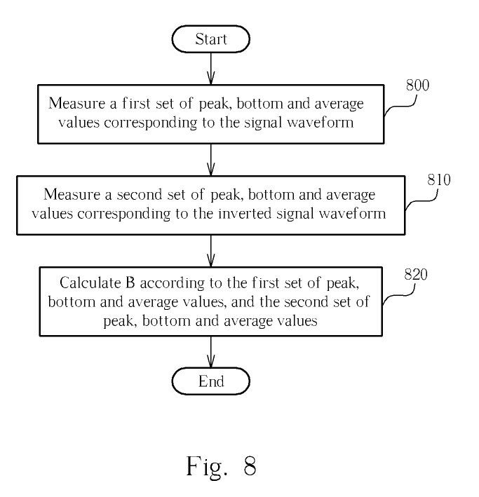

FIG. 8 illustrates a flowchart describing a method of calculating a metric indicating a symmetry between a signal waveform and an inverted signal waveform according to an exemplary embodiment of the present invention. Provided that substantially the same result is achieved, the steps of the signal inversion method shown in FIG. 8 need not be in the exact order shown and need not be contiguous, that is, other steps can be intermediate. In this embodiment, calculating a metric indicating a symmetry of a signal waveform includes the following steps:

Step 800: Measure a first set of peak, bottom, and average values corresponding to the signal waveform.

Step 810: Measure a second set of peak, bottom, and average values corresponding to the inverted signal waveform.

Step 820: Calculate the metric indicating the symmetry of the signal waveform (β′) according to the first set of peak, bottom, and average values, and the second set of peak, bottom, and average values.

As will be apparent from the description of the previous embodiments, steps 800 and step 810 may be performed in parallel or in sequence depending upon the particular hardware implementation of the method.

According to the present invention, an apparatus and method for calculating a metric indicating a symmetry of a signal waveform without being affected by offsets of peak/bottom detectors is disclosed. The signal waveform is inverted to produce an inverted signal waveform. Afterwards a first set of peak, bottom, and average values is measured corresponding to the signal waveform by detecting a peak value of the signal waveform, detecting a bottom value of the signal waveform, and detecting an average value of the signal waveform; and a second set of peak, bottom, and average values is measured corresponding to the inverted signal waveform by detecting a peak value of the inverted signal waveform, detecting a bottom value of the inverted signal waveform, and detecting an average value of the inverted signal waveform. Finally, the metric indicating the symmetry of the signal waveform is calculated according to the first set of peak, bottom, and average values corresponding to the signal waveform, and the second set of peak, bottom, and average values corresponding to the inverted signal waveform. In this way, inherent differences between IC offsets and speed settings are compensated for. According to the present invention, a more accurate symmetry metric β is obtained. When utilized in an optical recorder, determination of the optimum writing power is simplified, and overall write quality and error reduction rates are improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for calculating a metric indicating a symmetry of a signal waveform, the apparatus comprising:
a signal inverter coupled to the signal waveform for producing an inverted signal waveform;
a peak level detector;
a bottom level detector;
a signal averaging unit; and
an arithmetic unit coupled to the peak level detector, the bottom level detector, and the signal averaging unit for calculating the metric indicating the symmetry of the signal waveform according to a first set of peak, bottom, and average values corresponding to the signal waveform, and a second set of peak, bottom, and average values corresponding to the inverted signal waveform.

2. The apparatus of claim 1, wherein the signal inverter is coupled to the peak level detector, the bottom level detector, and the signal averaging unit; and the peak level detector, the bottom level detector, and the signal averaging unit are for measuring the first set of peak, bottom, and average values corresponding to the signal waveform, and for measuring the second set of peak, bottom, and average values corresponding to the inverted signal waveform.

3. The apparatus of claim 2, wherein the signal inverter is further for producing an intermittent signal, the intermittent signal comprising the inverted signal waveform and the signal waveform being time division multiplexed; and the intermittent signal is coupled to the peak level detector, the bottom level detector, and the signal averaging unit.

4. The apparatus of claim 3, further comprising a storage unit coupled to the arithmetic unit;
wherein, in a first stage of operation, the signal inverter is for outputting the intermittent signal as one of the signal waveform or the inverted signal waveform; and the arithmetic unit is for storing into the storage unit a value corresponding to peak, bottom, and average values as measured in the first stage of operation by the peak level detector, the bottom level detector, and the signal averaging unit; and
in a second stage of operation, the signal inverter is for outputting the intermittent signal as one of the signal waveform or the inverted signal waveform not being outputted in the first stage of operation; and the arithmetic unit is for calculating the metric indicating the symmetry of the signal waveform according to the value stored in the storage unit and peak, bottom, and average values as measured in the second stage of operation by the peak level detector, the bottom level detector, and the signal averaging unit.

5. The apparatus of claim 1 wherein the signal inverter includes a differential gain stage and is for simultaneously outputting the signal waveform and the inverted signal waveform as a differential pair.

6. The apparatus of claim 5, further comprising a multiplexer being coupled to the differential pair, the multiplexer for selecting one of the signal waveform or the inverted signal waveform to thereby generate an intermittent signal;
the intermittent signal comprising the inverted signal waveform and the signal waveform being time division multiplexed; and the intermittent signal being coupled to the peak level detector, the bottom level detector, and the signal averaging unit.

7. The apparatus of claim 6, further comprising a storage unit coupled to the arithmetic unit;
wherein, in a first stage of operation, the multiplexer is for outputting the intermittent signal as one of the signal waveform or the inverted signal waveform; and the arithmetic unit is for storing into the memory unit a value corresponding to peak, bottom, and average values as measured in the first stage of operation by the peak level detector, the bottom level detector, and the signal averaging unit; and
in a second stage of operation, the multiplexer is for outputting the intermittent signal as one of the signal waveform or the inverted signal waveform not being outputted in the first stage of operation; and the arithmetic unit is for calculating the metric indicating the symmetry of the signal waveform according to the value stored in the storage unit and peak, bottom, and average values as measured in the second stage of operation by the peak level detector, the bottom level detector, and the signal averaging unit.

8. The apparatus of claim 5, wherein the signal waveform outputted by the differential gain stage is coupled to the peak level detector, the bottom level detector, and the signal averaging unit; and the peak level detector, the bottom level detector, and the signal averaging unit are for measuring the first set of peak, bottom, and average values corresponding to the signal waveform.

9. The apparatus of claim 8, further comprising:
a second peak detector coupled to the inverted signal waveform outputted by the differential gain stage for measuring a peak value of the inverted signal waveform;
a second bottom detector coupled to the inverted signal waveform outputted by the differential gain stage for measuring a bottom value of the inverted signal waveform; and
a second average value unit coupled to the inverted signal waveform outputted by the differential gain stage for measuring the average value of the inverted signal waveform;
wherein the arithmetic unit is further coupled to the second peak detector, the second bottom detector, and the second average value unit for thereby receiving the second set of peak, bottom, and average values corresponding to the inverted signal waveform.

10. The apparatus of claim 9, wherein the arithmetic unit is for calculating the metric indicating the symmetry of the signal waveform in a single stage of operation according to the first set of peak, bottom, and average values corresponding to the signal waveform and the second set of peak, bottom, and average values corresponding to the inverted signal waveform.

11. The apparatus of claim 1, wherein the signal waveform corresponds to a read signal from a write procedure of optical disc device during disc recording.

12. The apparatus of claim 11, wherein the metric indicating the symmetry of a signal waveform is used to optimize power control of the write procedure during optical disc recording.

13. The apparatus of claim 1, wherein the signal averaging unit is a low pass filter.

14. The apparatus of claim 1, wherein the signal inverter is a gain controlled operational amplifier.

15. A method for calculating a metric indicating a symmetry of a signal waveform, the method comprising:
inverting the signal waveform to produce an inverted signal waveform;
measuring a first set of peak, bottom, and average values corresponding to the signal waveform by detecting a peak value of the signal waveform, detecting a bottom value of the signal waveform, and detecting an average value of the signal waveform;
measuring a second set of peak, bottom, and average values corresponding to the inverted signal waveform by detecting a peak value of the inverted signal waveform, detecting a bottom value of the inverted signal waveform, and detecting an average value of the inverted signal waveform; and
calculating the metric indicating the symmetry of the signal waveform according to the first set of peak, bottom, and average values corresponding to the signal waveform, and the second set of peak, bottom, and average values corresponding to the inverted signal waveform.

16. The method of claim 15, further comprising:
producing an intermittent signal formed by the inverted signal waveform and the signal waveform being time division multiplexed; and
measuring the first and second sets of peak, bottom, and average values according to the intermittent signal

17. The method of claim 16, further comprising:
providing a storage unit;
outputting the intermittent signal as one of the signal waveform or the inverted signal waveform in a first stage of operation;
storing into the storage unit a value corresponding to peak, bottom, and average values as measured in the first stage of operation;
outputting the intermittent signal as one of the signal waveform or the inverted signal waveform not being outputted in the first stage of operation in a second stage of operation; and
calculating the metric indicating the symmetry of the signal waveform according to the value stored in the storage unit and peak, bottom, and average values as measured in the second stage of operation.

18. The method of claim 15, wherein inverting the signal waveform to produce the inverted signal waveform further comprises simultaneously outputting the signal waveform and the inverted signal waveform as a differential pair.

19. The method of claim 18, further comprising:
selecting one of the signal waveform or the inverted signal waveform at a time from the differential pair to thereby generate an intermittent signal, the intermittent signal being formed by the inverted signal waveform and the signal waveform being time division multiplexed;

20. The method of claim 19, further comprising:
providing a storage unit;
selecting one of the signal waveform or the inverted signal waveform as the intermittent signal in a first stage of operation;
storing into the storage unit a value corresponding to peak, bottom, and average values as measured in the first stage of operation;
selecting one of the signal waveform or the inverted signal waveform not being outputted in the first stage of operation as the intermittent signal in a second stage of operation; and
calculating the metric indicating the symmetry of the signal waveform according to the value stored in the storage unit and peak, bottom, and average values as measured in the second stage of operation.

21. The method of claim 18 further comprising:
simultaneously measuring the first set of peak, bottom, and average values corresponding to the signal waveform and the second set of peak, bottom, and average values corresponding to the inverted signal waveform; and
calculating the metric indicating the symmetry of the signal waveform in a single stage of operation according to the first set of peak, bottom, and average values corresponding to the signal waveform and the second set of peak, bottom, and average values corresponding to the inverted signal waveform.

22. The method of claim 15, wherein the signal waveform corresponds to a read signal from a write procedure of optical disc device during disc recording.

23. The method of claim 22, further comprising optimizing power control of the write procedure during optical disc recording utilizing the metric indicating the symmetry of a signal waveform.

24. The method of claim 15, wherein detecting the average value of the signal waveform further comprises low pass filtering the signal waveform, and detecting the average value of the inverted signal waveform further comprises low pass filtering the inverted signal waveform.

25. The method of claim 15, further comprising providing a gain controlled operational amplifier for inverting the signal waveform to produce the inverted signal waveform.

26. An apparatus for calculating a metric indicating a symmetry between a signal waveform and an inverted signal waveform, the apparatus comprising:
a first peak level detector for detecting a peak value of a signal;
a first bottom level detector for detecting a bottom value of the signal;
a first signal averaging unit for detecting an average value of the signal;
a second peak level detector for detecting a peak value of an inverted signal;
a second bottom level detector for detecting a bottom value of the inverted signal;
a second signal averaging unit for detecting an average value of the inverted signal; and
an arithmetic unit coupled to the first peak level detector, the first bottom level detector, the first signal averaging unit, the second peak level detector, the second bottom level detector, and the second signal averaging unit, the arithmetic unit calculating the metric indicating the symmetry of the signal waveform according to a first set of peak, bottom and average values corresponding to the signal waveform, and a second set of peak, bottom, and average values corresponding to the inverted signal waveform.

27. An apparatus for calculating a metric indicating a symmetry between a signal waveform and an inverted signal waveform, the apparatus comprising:
a peak level detector;
a bottom level detector;
a signal averaging unit; and
a multiplexer coupled to the signal waveform and the inverted signal waveform, the multiplexer selecting one of the signal waveform or the inverted signal waveform to generate an intermittent signal, wherein the intermittent signal comprises the inverted signal waveform and the signal waveform being time division multiplexed, and the intermittent signal being coupled to the peak level detector, the bottom level detector, and the signal averaging unit.

28. A method for calculating a metric indicating a symmetry between a signal waveform and an inverted signal waveform, the method comprising:
measuring a first set of peak, bottom, and average values corresponding to the signal waveform by detecting a peak value of the signal waveform, detecting a bottom value of the signal waveform, and detecting an average value of the signal waveform;
measuring a second set of peak, bottom, and average values corresponding to the inverted signal waveform by detecting a peak value of the inverted signal waveform, detecting a bottom value of the inverted signal waveform, and detecting an average value of the inverted signal waveform; and
calculating the metric indicating the symmetry of the signal waveform according to the first set of peak, bottom, and average values corresponding to the signal waveform, and the second set of peak, bottom, and average values corresponding to the inverted signal waveform.

29. The method of claim 28, further comprising:
providing a storage unit;
selecting one of the signal waveform or the inverted signal waveform as the intermittent signal in a first stage of operation;
storing into the storage unit a value corresponding to peak, bottom, and average values as measured in the first stage of operation;
selecting one of the signal waveform or the inverted signal waveform not being outputted in the first stage of operation as the intermittent signal in a second stage of operation; and
calculating the metric indicating the symmetry of the signal waveform according to the value stored in the storage unit and peak, bottom, and average values as measured in the second stage of operation.

30. The method of claim 29 further comprising:
simultaneously measuring the first set of peak, bottom, and average values corresponding to the signal waveform and the second set of peak, bottom, and average values corresponding to the inverted signal waveform; and
calculating the metric indicating the symmetry of the signal waveform in a single stage of operation according to the first set of peak, bottom, and average values corresponding to the signal waveform and the second set of peak, bottom, and average values corresponding to the inverted signal waveform.
